(19) United States
(12) Patent Application Publication
(10) Pub. No.: US 2005/0023799 A1
(43) Pub. Date: Feb. 3, 2005

(54) Easily foldable golf cart

(76) Inventor: Wen-Tsan Lin, Taichung (TW)

Correspondence Address: WEN-TSAN LIN, 235 Chung-Ho, Box 8-24, Taipei, TW

(21) Appl. No.: 10/628,642

(22) Filed: Jul. 29, 2003

(51) Int. Cl. B62B 3/00

(52) U.S. Cl. 280/641; 280/655

(57) ABSTRACT

A golf cart includes a cart body, a rotatable freely joint means, and a braking means. The braking means further comprises at least one first buckling element, at least one second buckling element, at least one confining element which is installed between the bushes and the sleeve and can freely move axially therebetween, and a control means. When the button is released, the elastomer is released so that the confining element is pushed to the bush. Thereby, the bush of the joint means rotates with respect to the sleeve freely. The first joint and the second joint can be operated to expand or close the golf cart. When the button is tightened, the bushes can not move with respect to the sleeve.

### FIELD OF THE INVENTION

The present invention relates to golf carts, and particularly to a golf cart which comprises a joint means so that the cart body of the present invention can be folded or expanded easily by the joint means. Thereby, it is easy to be carried out, stored or transferred with a smaller space.

### BACKGROUND OF THE INVENTION

In the prior art golf cart, the golf cart has a fixed structure so that the volume of the cart body is larger and thus it is inconvenient to carry and store the golf cart. To improve the defects in the prior art, there are some kinds of foldable golf carts are developed. However, these prior art golf carts can not be folded easily and conveniently. Thereby, there still is an eager demand to improve the prior art-defects.

### SUMMARY OF THE INVENTION

Accordingly, the primary object of the present invention is to provide a golf cart which comprises a joint means so that the cart body of the present invention can be folded or expanded easily by the joint means. Thereby, it is easy to be carried out, stored or transferred with a smaller space.

To achieve above objects, the present invention provides a golf cart comprises the following elements.

A cart body includes at least one first portion and one second portion.

A joint means includes at least one first joint, one second joint and one spindle; the first joint having a pair of symmetric bushes. The second joint has a sleeve corresponding to the pair of bushes. The sleeve is received in between the bushes and being rotatable. One end of the spindle has a threaded section. The spindle passes through the two bushes and the sleeve. The first portion of the cart body is combined to the first joint; and the second portion of the cart body is combined to the second joint.

A braking means further comprises the following elements.

At least one first buckling element is installed at an inner surface of one bush.

At least one second buckling element is installed to the inner surface of the sleeve.

At least one confining element is embedded between the first buckling element and the second buckling element and is confined by the first buckling element and the second buckling element so as only to move axially in the bushes and the sleeve.

A control means serves for controlling the axial movement of the confining element. The control means includes at least one button which is rotatable and axially moves and is installed on the spindle; the control means having an elastomers. The confining element always retains on the position of the bush.

When the button is released, the elastomer is released so that the confining element is pushed to the bush. Thereby, the bush of the joint means rotates with respect to the sleeve freely. The first joint and the second joint can be operated to expand or close the golf cart. When the button is tightened, the bushes can not move with respect to the sleeve.

The various objects and advantages of the present invention will be more readily understood from the following detailed description when read in conjunction with the appended drawing.

### BRIEF DESCRIPTION OF THE DRAWINGS

FIG. 1 is a schematic perspective view of the present invention.

FIG. 2 is a schematic perspective view of the present invention, where the present invention is in folding state.

FIG. 3 is an exploded perspective view of the joint means in the first embodiment of the present invention.

FIG. 4 is a schematic cross sectional view showing the joint means in the first embodiment of the present invention is expanded.

FIG. 5 is a schematic cross sectional view of the first embodiment of the present invention, where the joint means of the present invention is screwed tightly.

FIG. 6 is a schematic cross sectional view of the joint means of the second embodiment.

FIG. 7 is a schematic cross sectional view of the joint means of the third embodiment.

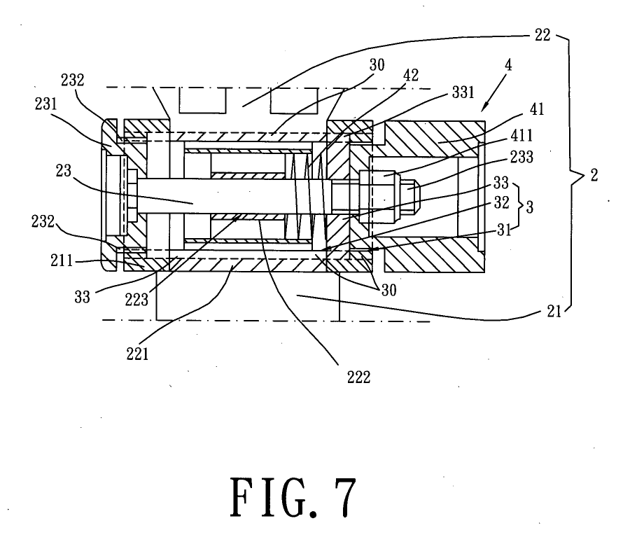

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

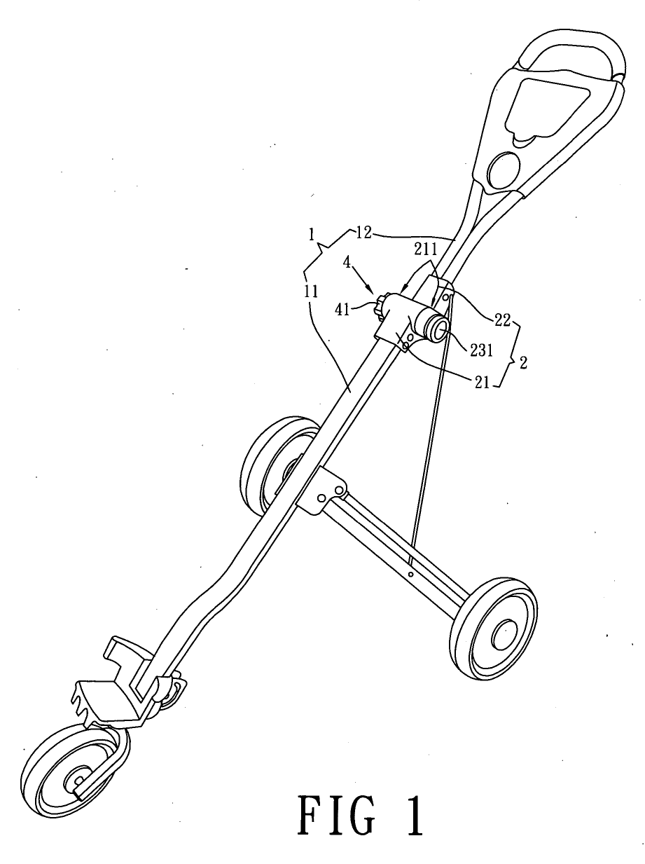

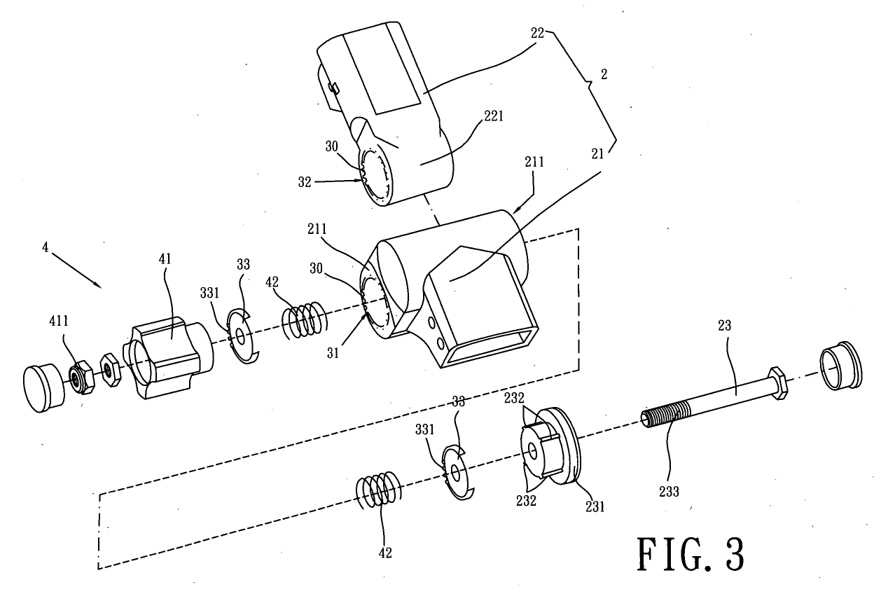

Referring to FIGS. 1 and 3, the golf cart of the present invention is illustrated. The golf cart includes a cart body 1, a rotatable freely joint means 2, and a braking means 3. The braking means 3 further comprises at least one first buckling element 31, at least one second buckling element 32, at least one confining element 33, and a control means 4.

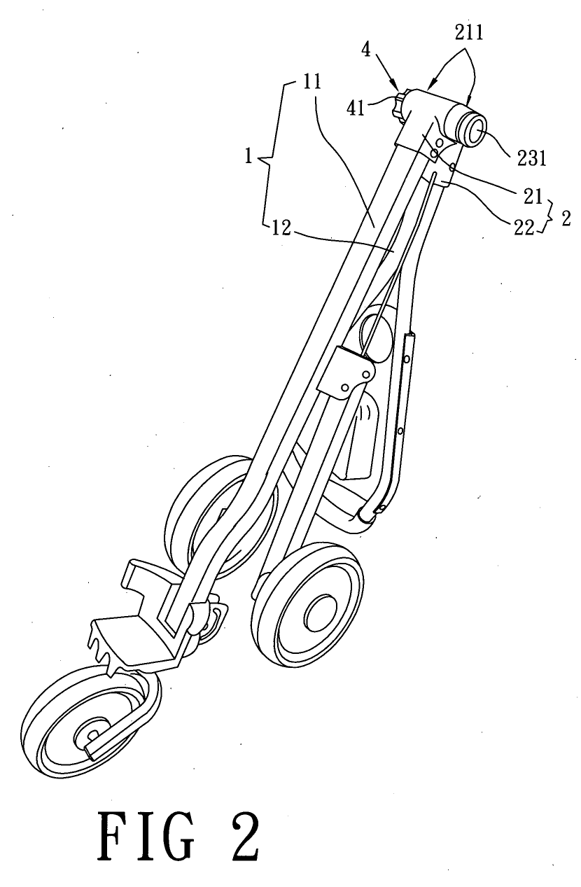

With reference to FIGS. 1 and 2, the cart body 1 the present invention includes at least one first portion 11 and one second portion 12.

With reference to FIGS. 1 to 4, the joint means 2 includes at least one first joint 21, one second joint 22 and one spindle 23. The first joint 21 includes has a pair of symmetric bushes 211. The second joint 22 has a sleeve 221 corresponding to the pair of bushes 211. The sleeve 221 is received in between the bushes 211 and is rotatable. One end of the spindle 23 has a threaded section 233. The spindle 23 passes through the two bushes 211 and the sleeve 221. The first portion 11 of the cart body 1 is combined to the first joint 21 and the second portion 12 of the cart body 1 is combined to the second joint 22.

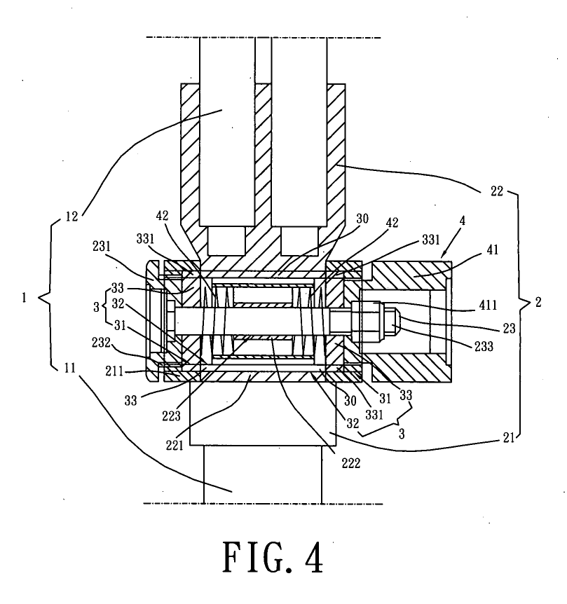

Referring to FIGS. 3 and 4, the first buckling element 31 of the braking means 3 of the present invention is installed at an inner surface of one bush 211 and the second buckling element 32 is installed to the inner surface of the sleeve 221. Besides, the confining element 33 is embedded between the first buckling element 31 and the second buckling element 32 and is confined by the first buckling element 31 and the second buckling element 32 so as only to move axially in the bush-es 211 and the sleeve 221.

With reference to FIG. 3, each of the first buckling element 31 and the second buckling element 32 is formed with a concave gear-like element 30 and the confining element 33 is formed as a convex gear-like body 331 configured with respect to the concave gear-like elements 30 of the bushes 211 and the sleeve 221.

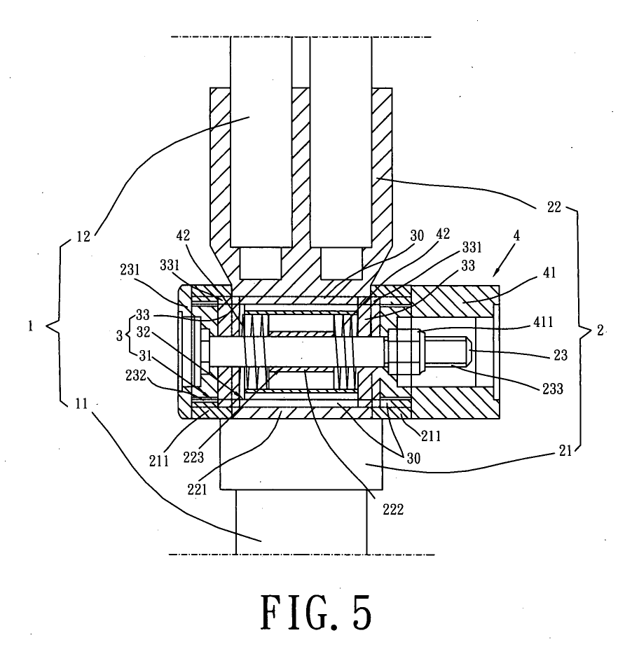

With reference to FIGS. 3 and 5, the control means 4 has a portion for controlling the axial movement of the confining element 33. The control means 4 includes at least one button 41 which is rotatable and axially moves and is installed on the spindle 23.

The control means 4 of the present invention has elastomers 42. The confining element 33′ always retains on the position of the bush 211. The elastomers 42 are selected from a compressible spring or an elastic rubber.

Referring to FIGS. 4 to 6, in the present invention, a resisting element 222 is installed in the interior of the sleeve 221. The resisting element 222 is a cylindrical body and has an axial hole 223 for being passed by the spindle 23. The outer edges of the end portions of the resisting element 222 resist against the elastomers 42.

With reference to FIGS. 3 to 5, the spindle 23 of the present invention further includes an end bush 231. The end bush 231 is at an end near the button 41. The end bush 231 can not radially or rotatably move with respect to the spindle 23. A periphery of the end bush 231 has at least one buckling protrusions 232. Thereby, when the spindle 23 looks to the spindle 23, the buckling protrusions 232 of the end bush 231 can be embedded in the concave gear-like element 30 of the bush 211 so as to prevent the spindle 23 from idle rotation.

With reference to FIGS. 1 to 4, in above structure, when the cart body 1 of the present invention is expanded for adjustment, after the button 41 is released, the elastomer 42 is released so that the confining element 33 is pushed to the bush 211, as shown in FIG. 4. Thereby, the bush 211 of the joint means 2 can rotate with respect to the sleeve 221 freely. Moreover, the first joint 21 and the second joint 22 can be operated to expand or close the golf cart.

Further, when the button 41 is tightened, the button 41 will push the confining element 33 to be between the bush 211 and the sleeve-221, as shown in FIG. 5 so that the first buckling element 31 and the second buckling element 32 are confined by the confining element 33. Thus, the bushes 211 and the sleeve 221 can not move with respect to one another so as to fix the joint means 2.

With reference to FIGS. 3 and 4, in the present invention, the interior of the button 41 has a tightening nut 411. Thereby, by the screwing of the button 41 and the spindle 23 by using the tightening nut 411, when adjusting the button 41, it will not loose or fall down.

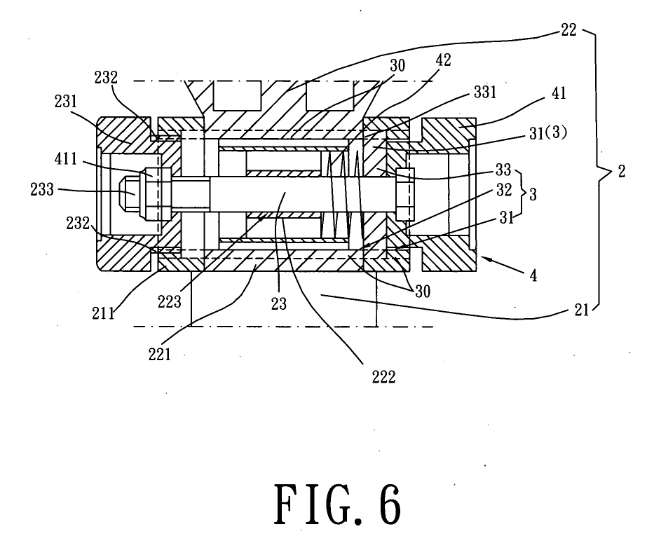

Referring to FIG. 6, the second embodiment of the control means 4 of the present invention is illustrated. The spindle 23 of the joint means 2 can not rotate with respect to the button 41 or the two are combined as an integral body. The threaded section 233 at another end of the spindle 23 is screwed to the end bush 231.

Thereby, from above description, the cart body of the present invention can be folded or expanded easily by the joint means. Thereby, it is easy to be carried out, stored or transferred with a smaller space.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A golf cart comprising:
a cart body including at least one first portion and one second portion;
a joint means including at least one first joint, one second joint and one spindle; the first joint having a pair of symmetric bushes; the second joint having a sleeve corresponding to the pair of bushes; the sleeve being received in between the bushes and being rotatable; the spindle passing through the two bushes and the sleeve; the first portion of the cart body being combined to the first joint; and the second portion of the cart body being combined to the second joint;
a braking means further comprising:
at least one first buckling element installed at an inner surface of one bush;
at least one second buckling element being installed to the inner surface of the sleeve;
at least one confining element embedded between the first buckling element and the second buckling element and being confined by the first buckling element and the second buckling element so as only to move axially in the bushes and the sleeve;
a control means for controlling the axial movement of the confining element; the control means including at least one button which is rotatable and axially moves and is installed on the spindle; the control means having an elastomers; the confining element always retaining on the position of the bush;
wherein when the button is released, the elastomer is released so that the confining element is pushed to the bush; thereby, the bush of the joint means rotates with respect to the sleeve freely; the first joint and the second joint serves to expand or fold the golf cart; when the button is tightened, the bushes can not move with respect to the sleeve.

2. The golf cart as claimed in claim 1, wherein each of the first buckling element and the second buckling element is formed with a concave gear-like element and the confining element is formed as a convex gear-like body configured with respect to the concave gear-like elements of the bushes and the sleeve.

3. The golf cart as claimed in claim 1, wherein a resisting element is installed in the interior of the sleeve; the resisting element is a cylindrical body and has an axial hole for being passed by the spindle; an outer edges of the end portions of the resisting element resist against the elastomers.

4. The golf cart as claimed in claim 1, wherein the spindle includes an end bush; the end bush is at an end near the button; the end bush can not radially or rotatably move with respect to the spindle.

5. The golf cart as claimed in claim 1, wherein a periphery of the end bush has at least one buckling protrusions.

6. The golf cart as claimed in claim 1, wherein the elastomers are selected from a compressible spring or an elastic rubber.

7. The golf cart as claimed in claim 1, wherein a tightening nut is installed in an interior of the button.

8. The golf cart as claimed in claim 1, further comprising an end bush; the spindle is un-rotatable with respect to the button; and another end of the spindle is screwed to the end bush.

9. The golf cart as claimed in claim 1, further comprising an end bush; the spindle is un-rotatable with respect to the end bush; and another end of the spindle is screwed to the button.

10. The golf cart as claimed in claim 4, wherein the spindle is integrally formed with the end bush.

11. The golf cart as claimed in claim 8, wherein the spindle is integrally formed with the button.

12. The golf cart as claimed in claim 9, wherein the spindle is integrally formed with the end bush.
